(19) United States
(12) Patent Application Publication
(10) Pub. No.: US 2019/0370367 A1
(43) Pub. Date: Dec. 5, 2019

(54) OPTIMIZING DATA REFRESH TIMING BASED ON TELEMETRY

(71) Applicant: MICROSOFT TECHNOLOGY LICENSING, LLC, Redmond, WA (US)

(72) Inventor: Roy Moshe GAL, Herzliya (IL)

(21) Appl. No.: 15/994,952

(22) Filed: May 31, 2018

(51) Int. Cl. G06F 17/30

(52) U.S. Cl. CPC G06F 17/30365; G06F 17/30371; G06F 17/30368

(57) ABSTRACT

Methods, computer systems, computer-storage media, and graphical user interfaces are provided for facilitating enhancement of data refresh timing. In one embodiment, user data indicating a user pattern for accessing a dataset is obtained. A data refresh duration indicating a duration of time used to perform data refreshes can be identified. Using the user data and the data refresh duration, a future time at which to perform a data refresh is determined. Generally, the future time is predicted to enable the data refresh to occur prior to a user accessing the dataset. Thereafter, a data refresh can be automatically initiated at the determined future time.

### BACKGROUND

Consumers of data oftentimes desire the data to be up-to-date. In this regard, consumers generally desire to view the most recent information so that they are provided with accurate information and can make informed decisions. Ensuring that the most recent data is utilized to present information to consumers, however, can be costly and time consuming. For example, various resources are utilized to refresh data in a dataset. As such, the more frequently data is refreshed, the more resources are utilized to perform the data refreshes and are unavailable for performing other functions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating optimization of data refresh timing using telemetry. In this way, user patterns for accessing data can be analyzed and used to determine an appropriate schedule for refreshing data. Advantageously, utilizing user patterns to determine times for data refreshes enables a more appropriate utilization of resources. For example, during times at which a user(s) is not accessing data, a system can forego data refreshes to reserve resources for performing other functions. On the other hand, when a user is likely to access data, a data refresh can be performed such that the user is provided with up-to-date information without having to wait for the data refresh to be performed.

In accordance with various embodiments described herein, various types of data can be analyzed to generate a refresh schedule. For example, optimization of refresh scheduling can take into account source utilization data such that a data refresh can be prevented when there is no, or minimal, new data. Conversely, source utilization data can be used to schedule data refreshes when a threshold amount of data has been added to, or modified within, a dataset. In addition to source utilization data, a refresh time duration can be used to determine a refresh time. For example, to adequately perform a data refresh prior to a user viewing data, an amount of time it takes to perform a data refresh can be taken into account. Further, refresh optimization preferences that indicate a user's preference for optimizing an aspect of a data refresh can also be used to determine a refresh schedule. For example, a user may indicate a desire to optimize data freshness. In such a case, data refreshes are more likely to occur more frequently.

### BRIEF DESCRIPTION OF THE DRAWINGS

The technology described herein is described in detail below with reference to the attached drawing figures, wherein:

FIG. 1 is a block diagram of an exemplary system for facilitating identification of data refresh timing, suitable for use in implementing aspects of the technology described herein;

FIG. 2 is an example data refresh engine in accordance with aspects of the technology described herein;

FIG. 3 is an exemplary process flow for scheduling and performing data refreshes, in accordance with embodiments described herein;

FIG. 4 provides a first example method for facilitating enhancement of data refresh timing, in accordance with aspects of the technology described herein;

FIG. 5 provides a second example method for facilitating enhancement of data refresh timing, in accordance with aspects of the technology described herein;

FIG. 6 provides a third example method for facilitating enhancement of data refresh timing, in accordance with aspects of the technology described herein; and

FIG. 7 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Refreshing data generally refers to updating data in a dataset, for example, stored in association with a data warehouse. The refreshed or updated data can then be used to provide current data to a user. For instance, upon refreshing data, the updated data can be analyzed and used to provide the most current information to a user, e.g., via a report, dashboard, application, webpage, or the like. By way of example only, to refresh data in a dataset, information associated with the dataset can be used to connect to defined data sources, query for updated data, and then load the updated data into the dataset. The refreshed data can then be used to update (e.g., automatically) visualizations provided to users, for instance, via a report, dashboard, application, webpage, etc.

In conventional systems, a refresh can be initiated and performed based on a user-selected demand (e.g., user selects a refresh button or icon) or based on a manually-defined refresh schedule. To refresh based on a manually-defined refresh schedule, a user typically selects a timing schedule (e.g., hourly, daily, weekly) for refreshing data that is appropriate for the user's data or system. For example, an expert within an organization (e.g., operating extract, transform and load (ETL) operations or other database refreshes) may estimate the times at which the data should be refreshed and schedule accordingly. As another example, for mobile applications, a developer-specified heuristic may be used to schedule refreshes, for instance, to update the application on launch and, thereafter, periodically in the background.

Such manual initiations of data refreshes and/or manually determined refresh schedules, however, may not provide optimal times for refreshing data. For example, complex refresh flows (e.g., ETL and other database update flows) consume an extensive amount of resources. Accordingly, too frequently scheduled refresh flows can over-utilize resources. Further, in cases that an entity pays for a refresh execution or compute (e.g., via SAS infrastructure), an unnecessary data refresh results in an unnecessary monetary payment. On the other hand, too infrequently scheduled refreshes can result in stale data being utilized and/or provided. As another example, for mobile applications, upon a manual user refresh selection, the user generally has to wait for the data to be refreshed in order to be provided with updated information. While periodic scheduled refreshes may refresh data more often, such periodic refreshes can unduly consume resources and, yet, may still not be at performed at a time desired by a user (e.g., as the user desires to view updated information).

Accordingly, embodiments described herein are directed to enhancing data refresh timing utilizing telemetry. In embodiments, a user's pattern for accessing or requesting data (e.g., time of day, frequency, day of week, etc.) can be assessed, among other things, and used to identify a time or schedule for performing a data refresh(s). In this regard, data can be refreshed at a time at which the user is more likely to desire the updated data enabling more up-to-date information to be provided to a user.

Advantageously, utilizing telemetry to determine refresh timing improves resource utilization. For example, assume a user generally sleeps during an eight hour period of time without viewing any data. In such a case, resource utilization during that eight hour time period may be significantly reduced as data does not need not be refreshed during that time period. In addition to improving resource utilization, utilizing telemetry also enables data to be refreshed in advance of access by the user. In particular, a predicted or inferred future time at which to refresh data is intended to be “just-in-time” to increase efficiency for the user. For example, just before a user is likely to access or view data, the data can be refreshed such that the most up-to-date information is analyzed and/or presented to the user.

In operation, to facilitate enhancement or optimization of data refresh timing, telemetry is utilized to predict or infer a future time(s) at which to perform a data refresh. Telemetry generally refers an automated communications process that includes collecting various data (e.g., measurements). Such data can be initially collected at remote locations or systems and transmitted to a receiving system for data monitoring. In accordance with embodiments described herein, telemetry data collection may occur at user devices and/or source devices. Data collected at user devices is generally referred to herein as user data (or user telemetry data), while data collected at source devices is generally referred to herein as source utilization data (or source telemetry data). As described more fully below, such user data and/or source utilization data can be utilized to identify or infer a data refresh timing. A data refresh timing or refresh schedule can refer to a time(s) or schedule at which to initiate or perform a data refresh. A data refresh may refer to a refresh or update of data in a dataset and/or a refresh of information provided to a user. Accordingly, a data refresh may include any number of various refresh flows, such as ETL (extra, transform, load process), etc.

In embodiments and as further described herein, in addition to using user data (e.g., indicating a user(s) pattern(s) for accessing information) and/or source utilization data (e.g., indicating a previous refresh, such as a last refresh date), a data refresh duration (e.g., indicating a length of time for performing a data refresh) and/or a refresh optimization preference (e.g., optimize for cost or data freshness) may be used to identify a data refresh schedule. By way of example only, assume a user pattern indicates that a user views data each morning at 8:00 am. Further assume that source utilization data indicates a five minute time duration is needed to perform a data refresh. As such, a data refresh may be automatically scheduled for 7:55 am each morning. Further, assume a user indicates a desire to also optimize for cost or resources. In such a case, when it is determined, for example, that there is no new data to refresh or that a user recently manually initiated a data refresh, the 7:55 am scheduled data refresh may be omitted for the day. Various combinations and usage of such data may be employed in accordance with embodiments described herein.

Further, as can be appreciated, the refresh scheduling can be dynamically adapted to obtained input data. For example, continuing with the previous example, assume that the user begins reviewing data at 7:00 am as opposed to 8:00 am. In such a case, the refresh schedule can be automatically adjusted to adapt to the user's schedule change.

As can be appreciated, and as discussed more fully below, a refresh schedule may be specific to a user, a group of users, an application, a system, and/or the like. For example, in some cases, a user pattern for a specific user is analyzed and used to generate a schedule for that user. In other cases, a user pattern associated with multiple users (e.g., users of a system) may be analyzed and used to generate a schedule for refreshing data for an entity. For example, in some cases, a refresh schedule may be based on usage patterns determined from a majority of users in an organization or may be based on specific, critical users, such as managers and decision makers.

### Overview of Exemplary Environments for Facilitating Enhancement of Data Refresh Timing

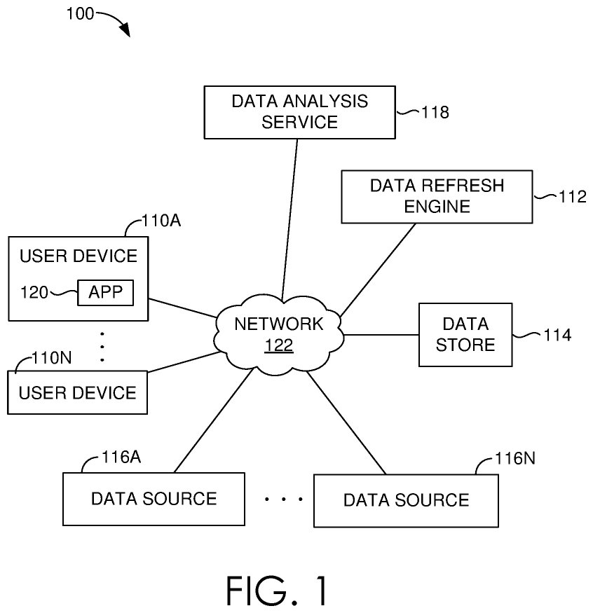

Referring initially to FIG. 1, a block diagram of an exemplary network environment 100 suitable for use in implementing embodiments of the invention is shown. Generally, the system 100 illustrates an environment suitable for facilitating enhancement or improvement of data refresh timing by, among other things, utilizing telemetry. The network environment 100 includes a user device 110a-110n (referred to generally as user device(s) 110), a data refresh engine 112, a data store 114, data sources 116a-116n (referred to generally as data source(s) 116), and a data analysis service 118. The user device 110a-110n, the data refresh engine 112, the data store 114, the data sources 116a-116n, and the data analysis service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments of the inventions disclosed throughout this document. Neither should the exemplary network environment 100 be interpreted as having any dependency or requirement related to any single component or combination of components illustrated therein. For example, the user device 110a-110n and data sources 116a-116n may be in communication with the data refresh engine 112 via a mobile network or the Internet, and the data refresh engine 112 may be in communication with data store 114 via a local area network. Further, although the environment 100 is illustrated with a network, one or more of the components may directly communicate with one another, for example, via HDMI (high-definition multimedia interface), DVI (digital visual interface), etc. Alternatively, one or more components may be integrated with one another, for example, at least a portion of the data refresh engine 112 and/or data store 114 may be integrated with the user device 110 and/or data analysis service 118. For instance, a portion of the data refresh engine 112 may be integrated with a server (e.g., data analysis service) in communication with a user device, while another portion of the data refresh engine 112 may be integrated with the user device (e.g., via application 120).

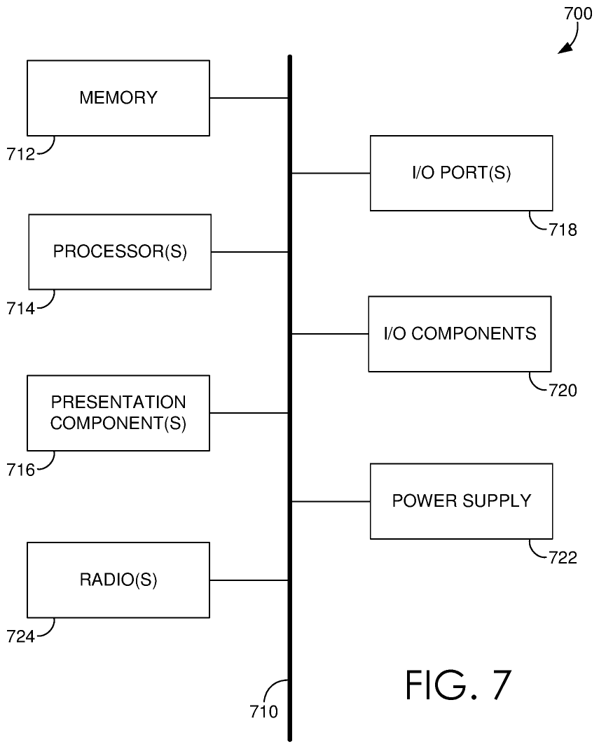

The user device 110 can be any kind of computing device capable of facilitating data refreshes and/or analyzing or presenting data. For example, in an embodiment, the user device 110 can be a computing device such as computing device 700, as described above with reference to FIG. 7. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating data refreshes and/or analyzing or presenting data. In some implementations, the application(s) comprises a web application, which can run in a web browser, and could be hosted at least partially server-side (e.g., via data analysis service 118). In addition, or instead, the application(s) can comprise a dedicated application. In some cases, the application is integrated into the operating system (e.g., as a service). As one specific example application, application 120 may be a business intelligence tool or other data analysis tool that provides various data and data visualizations. Such an application may be accessed via a mobile application, a web application, etc.

User device 110 can be a client device on a client-side of operating environment 100, while data refresh engine 112 and/or data analysis service 118 can be on a server-side of operating environment 100. Data refresh engine 112 and/or data analysis service 118 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 11, data refresh engine 112, and/or data analysis service 118 to remain as separate entities.

In an embodiment, the user device 110 is separate and distinct from the data refresh engine 112, the data store 114, the data sources 116, and the data analysis service 118 illustrated in FIG. 1. In another embodiment, the user device 110 is integrated with one or more illustrated components. For instance, the user device 110 may incorporate functionality described in relation to the data refresh engine 112. For clarity of explanation, we will describe embodiments in which the user device 110, the data refresh engine 112, the data store 114, the data sources 116, and the data analysis service 118 are separate, while understanding that this may not be the case in various configurations contemplated within the present invention.

As described, a user device, such as user device 110, can facilitate enhancing data refresh timing. A data refresh refers to a refresh or update of data, such that the refreshed data can be analyzed and/or provided to a user. Embodiments described herein are directed to identifying or inferring a time(s) at which to perform a data refresh(s) based on telemetry. As previously described, telemetry generally refers an automated communications process that includes collecting various data (e.g., measurements). Such data can be initially collected at remote locations or systems and transmitted to a receiving system for data monitoring. In accordance with embodiments described herein, telemetry data collection may occur at user devices 110, which may include collection of user data.

As such, user devices, or components associated therewith, can be used to collect various types of user data. For example, in some embodiments, user data may be obtained and collected at a user device via one or more sensors, which may be on or associated with one or more user devices and/or other computing devices. As used herein, a sensor may include a function, routine, component, or combination thereof for sensing, detecting, or otherwise obtaining information, such as user data, and may be embodied as hardware, software, or both.

User data may be any type of data associated with a user, such as user interactions, user activities, etc. By way of example and not limitation, user data may include data that is sensed or determined from one or more sensors, such as location information of mobile device(s), smartphone data (such as phone state, charging data, date/time, or other information derived from a smartphone), user-activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events; other user interactions with a user device, etc.) including user activity that occurs over more than one user device, user history, session logs, application data, contacts data, calendar and schedule data, notification data, social network data, news (including popular or trending items on search engines or social networks), online gaming data, ecommerce activity, and nearly any other source of data that may be sensed or determined as described herein. In addition to user data being collected at user devices, such as user devices 110, user data may obtained at the data analysis service 118, or other external server, for example, that collects data based on user interactions with user devices. User data can be obtained at a user device, or a server, in an ongoing manner (or at any time) and provided to the data refresh engine 112 to facilitate enhancement of identifying a refresh schedule.

In some cases, identification of a refresh time(s) or schedule may be initiated at the user device 110. For example, in some cases, a user may select an option or setting indicating to automatically determine a refresh schedule that is optimal for the user, an application (e.g., a specific business intelligence application), or a system. As can be appreciated, in some cases, a user of the user device 110 that may initiate identification of a refresh time is a user that can view information produced from updated or refreshed data. In additional or alternative cases, an administrator, programmer, or other individual associated with refreshed data, or dataset, may initiate identification of a refresh time(s) such that the individual is initiating scheduling of the data refreshes and/or providing refresh optimization preferences, but not necessarily a consumer or viewer of the refreshed data. By way of example only, an individual associated with the data analysis service 118 may provide refresh optimization preferences, as described more fully below, to provide preferences as to timing or frequency of data refreshes.

Refresh timing identification may be initiated and/or presented via an application 120 operating on the user device 110. In this regard, the user device 110, via an application 120, might allow a user to initiate a determination or identification of a suitable refresh timing. The user device 110 can include any type of application and may be a stand-alone application, a mobile application, a web application, or the like. In some cases, the functionality described herein may be integrated directly with an application or may be an add-on, or plug-in, to an application.

Such identification of a refresh time(s) may be initiated at the user device 110 in any manner. For instance, upon accessing a particular application, a user may be presented with, or navigate to, settings associated with data refreshes. In such a case, a user may be presented with one or more data refresh timing options. One data refresh timing option may be a user-selectable time schedule. For example, the user (e.g., entity administrator) may select to refresh each Monday morning. Another refresh timing option, and in accordance with embodiments herein, may be an automated data refresh optimization. In such a case, a user may select to have data automatically refreshed in a manner that is deemed optimal for the user, application, and/or system. By way of example only, upon a user selecting to determine a refresh schedule that is optimal for the user, application, and/or system, the data refresh engine 112 can determine an optimal refresh schedule using telemetry.

In some cases, a user may specify a preferred type of optimization, such as a cost optimization, resource optimization, and/or data freshness optimization. For instance, a user may be presented with a slider or adjustable control that enables the user to specify a preference, and/or an extent of preference, for how data refreshes are optimized. By way of example, a user may specify to optimize for data freshness such that the most recent data is typically used to analyze and present information. As another example, in cases in which an administrator or other individual provides an optimization preference for the system or service (e.g., data analysis service), assume a company has 1000 users. If a company administrator selects to optimize for maximum data freshness optimization, the data refresh schedule may be optimized for 95% of user needs such that data will be refreshed each day. On the other hand, if the administrator selects to optimize for costs, then the data refresh schedule may be set to reduce costs (e.g., refresh data once a week). Although described as a slider or adjustable control, a user (e.g., a data viewer or administrator) may select optimization preferences in any number of ways.

The user device 110 (or other device operated by an entity administrator) can communicate with the data refresh engine 112 to provide user data, initiate identification of data refresh timing, and/or provide optimization preferences. In embodiments, for example, a user may utilize the user device 110 to initiate a determination of refresh timing via the network 122. For instance, in some embodiments, the network 122 might be the Internet, and the user device 110 interacts with the data refresh engine 112 (e.g., directly or via data analysis service 118) to initiate optimization of refresh timing. In other embodiments, for example, the network 122 might be an enterprise network associated with an organization. It should be apparent to those having skill in the relevant arts that any number of other implementation scenarios may be possible as well.

With continued reference to FIG. 1, the data refresh engine 112 generally manages data refreshes. The data refresh engine 112, according to embodiments, can be implemented as server systems, program modules, virtual machines, components of a server or servers, networks, and the like. At a high level, the data refresh engine 112 manages data refreshes in accordance with a time(s) for data refresh(s) determined based on telemetry. In particular, the data refresh engine 112 can collect or obtain user data, such as user data from user devices 110, and source utilization data, such as source utilization data from data sources 116. Data sources 116 may be any type of source providing data, for example, for use by a data analysis service 118. Generally, the data refresh engine 112 can receive user data and/or source utilization data from any number of devices. As such, the data refresh engine 112 can identify and/or collect data from various user devices, such as user devices 110a-110n, and sources, such as data sources 116a-116n. In this regard, the data refresh engine can retrieve or receive data collected or identified at various components, or sensors associated therewith.

Further, in some cases, the data refresh engine 112 can receive a user preference for refresh optimization initiated via the user device 110 (or other device). Refresh optimization preferences received from a device, such as user device 110, can include refresh optimization preferences that were manually or explicitly input by the user (input queries) as well as refresh optimization preferences that were automatically generated. Generally, the data refresh engine 112 can receive refresh optimization preferences from any number of devices. For example, in implementations in which refresh timing is specific to a user viewing information, refresh optimization preferences can be specified by various users such that the refresh timing is optimized in accordance with the user's preferences. In accordance with receiving a refresh optimization preference (e.g., via the user device 110 or administrator's device), the data analysis engine 112 can utilize telemetry to determine a data refresh time(s) or schedule based on the refresh optimization preference. As described, in various embodiments, a refresh optimization preference is not required.

The various collected data can be used to determine a time(s) for refreshing data. Such a determined time(s) is generally intended to optimize data refreshes. For example, a data refresh time may be optimized for freshness of data, refresh costs (minimize costs), and/or combination thereof. Upon determining a data refresh time or schedule, a dataset of data store 114 can be refreshed or updated in accordance with the determined time or schedule. In this way, refreshed data can be analyzed and/or provided to a user, such as via user device 110, in a more optimal manner. In embodiments, the data refresh engine 112 refreshes data such that refreshed data can be analyzed and/or provided to a user at the time a user wishes to view information. That is, data is updated in advance of a user desiring to view related information so that updated information can be efficiently provided to the user when the user is ready to view (without having to wait for the data to be refreshed).

The data analysis service 118 can reference the updated dataset in the data store 114 and use such data to perform data analysis and/or provide data to the user device 110. The data analysis service 118 may be any type of server or service that can analyze data and/or provide information to user devices. One example data analysis service 118 includes a business intelligence service, such as Power BI, by Microsoft®, that can provide various data visualizations for presentation to users. Although data analysis service 118 is shown separate from the data refresh engine 112, as can be appreciated, the data refresh engine can be integrated with the data analysis service 118, or other service or service. The user device 110 can present received data or information in any number of ways, and is not intended to be limited herein. As an example, information based on refreshed data can be presented via application 120 of the user device. Advantageously, performing data refreshes in accordance with a time schedule automatically generated based on user data and/or source utilization data enables updated information to be provided to a user in an efficient and timely manner. As such, a user will have desired information and can assess the information accordingly.

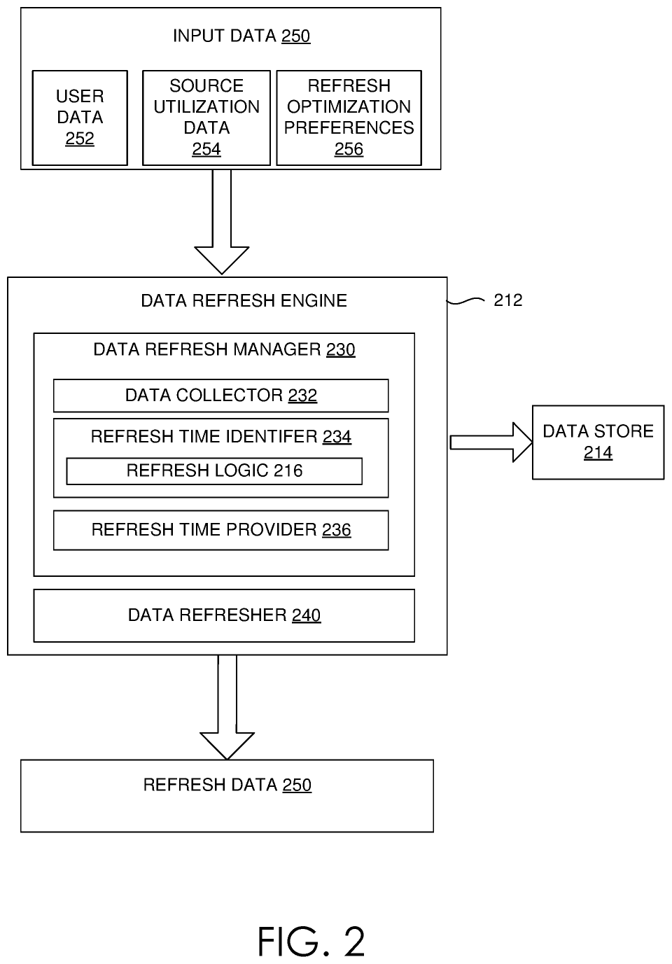

Turning now to FIG. 2, FIG. 2 illustrates an example data refresh engine 212. In embodiments, the data refresh engine 212 include a data refresh manager 230 and a data refresher 240. According to embodiments of the invention, the data refresh engine 212 can include any number of other components not illustrated. In some embodiments, one or more of the illustrated components 230 and 240 can be integrated into a single component or can be divided into a number of different components. Components 230 and 240 can be implemented on any number of machines and can be integrated, as desired, with any number of other functionalities or services.

The data refresh engine 212 can communicate with the data store 214. The data store 214 is configured to store various types of information accessible by the data refresh engine 212 and/or a data analysis service (e.g., data analysis service 118 of FIG. 1) or other server. In embodiments, data sources (such as data sources 116 of FIG. 1) and/or data refresher 240 provide data to the data store 214 for storage, which may be retrieved or referenced by a data analysis service, such as data analysis service 118 of FIG. 1.

In implementation, the data refresh manager 230 is generally configured to manage identification of refresh times or schedules. In embodiments, the data refresh manager 230 includes a data collector 232, a refresh time identifier 234, and a refresh time provider 236. Some embodiments of data refresh manager 230 may also utilize refresh logic 216, as described herein. The data collector 232 can receive input from various components for utilization in identifying a refresh time(s) at which data is to be refreshed. As previously described, the data collector 232 can receive input data 250, which can include user data 252, source utilization data 254, refresh optimization preferences 256, and/or the like. Such data can be received from any number of devices or components. For example, user data 252 may be received from various user devices, source utilization data 254 may be received from various data sources, and refresh optimization preferences 256 may be received from any various user devices and/or administrator devices.

As described, user data generally refers to data collected at user devices or services (servers) corresponding with user devices. Such data may include various types of data that indicate information about a user and/or user device. For example, user data may indicate various user interactions, user activity, user device information, user information, user preferences, etc. In this regard, user data can include information indicating user patterns, such as what data users are accessing or viewing and at what times. In implementations, the user devices providing such user data correspond with users that view data, for example, based on refreshed data. By way of example only, and with brief reference to FIG. 1, a user device running an application, such as application 120 on user device 110, that communicates with a data analysis service, such as data analysis service 118, may provide user data to the data refresh engine 112.

User data can be collected at various user devices in any number of ways, including utilization of sensors that capture information. In some cases, the data may be processed prior to being received at the data collector 232. Additionally or alternatively, the data may be processed at the data collector 232 (e.g., to identify user patterns, including data access/view times). The collected user data may be stored in data store 214, or another data store.

Source utilization data generally refers to data collected at source devices that indicates utilization of the source, or portion thereof. Source utilization data can indicate information related to the source, such as whether there is new data (e.g., since the last data refresh), an amount of new data (e.g., since the last data refresh), when data was updated (e.g., a most recent date/time for data updates), number of records added to a data source, revenue sum added to a data source, etc.

Source utilization data can be collected at various source devices in any number of ways, including utilization of sensors that capture information. In some cases, the data may be processed prior to be received at the data collector 232. Additionally or alternatively, the data may be processed at the data collector 232. The collected source data may be stored in data store 214, or another data store.

Refresh optimization preferences may also be received by the data collector 232. In this regard, the data collector 232 may obtain refresh optimization preferences from user devices and/or administrator devices. Such preferences may indicate a manner and/or an extent in which to optimize data refreshing timing. For example, a user or administrator may prefer to optimize data refreshing timing based on costs or data freshness. As previously described, refresh optimization preferences may be provided by a user device operated by a user viewing data or an administrator device operated by an individual managing data refreshes on behalf of an entity (e.g., company, etc.). Any refresh optimization preferences may be stored, for instance, at data store 214.

In addition to collecting various inputs from user devices and/or data sources, the data collector 232 can also obtain information associated with a refresh process(es), such as a length of time, or duration, for which it takes to complete a data refresh. In this regard, the data collector 232 can obtain an amount of time it takes to perform a data refresh. A refresh time duration can be measured using any number of beginning and/or ending events of a refresh process flow. For example, a data refresh duration may include the time to update the data in a data store and to provide information to a user based on the refreshed data. In other cases, a data refresh duration may include only the time to update the data in a data store. Further, a refresh time duration may depend on the dataset being updated, the specific application, or the specific system.

In such a case, a refresh time duration may be identified for various datasets. A data refresh duration can be stored, for example, at data store 214. In embodiments in which various data refresh durations correspond with different datasets, systems, or refresh flows, the data refresh durations can be stored in association therewith for subsequent reference. A refresh time duration may be received or determined based on information received from, for example, a data refresher, such as data refresher 240.

The refresh time identifier 234 can be used to identify a refresh time(s) at which to initiate or perform a data refresh(s). In particular, the refresh time identifier 234 can utilize data collected via data collector 232 to identify a time(s) refresh(s) or a time refresh schedule (e.g., series, set, or sequence of refresh times or time lapse therebetween). As such, the refresh time identifier 234 can predict or infer a future time or set of times at which to perform a data refresh.

To identify a time(s) at which to perform a data refresh(s), various data can be used. Embodiments described herein provide examples of various combinations of data that can be used to determine a refresh schedule, but are provided for illustrative purposes only. As can be appreciated, any combinations of data are contemplated within the scope for automatically determining a refresh schedule. Some embodiments of refresh time identifier utilize refresh logic 216 to determine refresh times.

Refresh logic 216 may include rules, conditions, associations, classification models, or other criteria, to identify likely future refresh times (or conditions warranting a data refresh) in conjunction with input data. For example, in one embodiment, refresh logic 216 may include an inference engine or behavior model for inferring likelihood of future access to data by one or more users, based on historical access information within user data 252. Refresh logic 216 may take different forms depending on the mechanism used to identify a likely future time for performing a data refresh. For example, the refresh logic 216 may include training data used to train a neural network that is used to evaluate user data to determine what conditions or contextual information exist at the time of (or associated with) the data access or presentation. By way of example and without limitation, such conditions or contextual information may include information such as what time of day, what day of week, which users access the data, what specific data is accessed, what is the frequency of access, information about available computing resources, what are the data deltas or what data that is accessed or likely to be accessed has been updated since the previous data access, what percentage of the data has changed or is likely to have changed between refresh times, what other events or circumstances occurred that are related to this data, or similar contextual or related information. In some embodiments, this information may also include explicit feedback from users or administrators, such as information indicating whether a particular, data refresh was useful, was not useful (e.g., the data had not changed or was no longer useful).

Refresh logic 216 may comprise a statistical model, fuzzy logic, neural network, finite state machine, support vector machine, logistic regression, clustering, or machine-learning techniques, similar statistical classification processes, or combinations of these to identify likely future data refresh times or conditions warranting a data refresh. In some embodiments, refresh logic 216 may specify types of input data 250 (e.g., (user data 252) that is considered a user data access or input data relevant to a data refresh, such as determining a refresh time. Such information may be used as features in a statistical or machine-learning model for pattern analysis to infer likely future refresh times.

As described, in various implementations, user data is used to identify a time at which to perform a data refresh. In this way, a refresh schedule can be predicted based on a user data (e.g., user's pattern for accessing data). In implementations in which a refresh schedule is determined for a specific user, the specific user's data accessing pattern can be assessed and used to predict when the user accesses data. Based on the user's predicted data access, a refresh schedule can be determined. For example, assume a user reviews data each morning, data refreshes can be scheduled prior to the time at which the user generally reviews data. As another example, assume a user does not review data during the hours of 10 pm and 7 am. In such a case, a refresh schedule can avoid including any data refreshes during that time period. Advantageously, the user can be provided with updated information when the user is ready to view the information, but may also avoid data refreshes when not needed (e.g., reducing bandwidth utilization and computes). In implementations in which a refresh schedule is determined for a system, user data for a group of users that access the system may be assessed and used to determine a refresh schedule. For example, assume a group of users review data one time per day. In such a case, data refreshes can be scheduled for each morning such that the users generally obtain updated information. Assume the group of users generally do not review data between the hours of 10 pm and 7 am. In such a case, the refresh schedule can avoid data refreshes during that time thereby reducing costs, computes, and resource utilization.

Source utilization data can additionally or alternatively be used to identify a time at which to perform a data refresh. Source utilization data may indicate whether any data is new, what data is new, when data was added, etc. Accordingly, a refresh schedule can be based on source utilization data such that resources are not over-utilized. For example, when there is not any new data, data has not been added within a certain amount of time, newly added data is below a threshold amount, etc., a time at which to perform a data refresh can be adjusted, delayed, or omitted. In this way, a data refresh can be avoided when there is no or limited new data. On the other hand, source utilization data can be used to avoid use of stale data. For example, a refresh schedule can be adjusted or a refresh time triggered when source utilization data indicates a threshold number of new records or data have been added to the data source.

Additionally or alternatively, refresh time duration can be used to identify a refresh schedule. A refresh time duration can indicate how long it takes to perform a data refresh or refresh flow. As described, a refresh time duration can be identified specific to a user, a group of users, an application, a system, a dataset, or combinations thereof. In various implementations, a refresh time duration may be an average, standard deviation, and/or median. Further, as can be appreciated, such refresh time durations may have variations in data, such as following a weekend, over holidays, certain days of the week, etc. Advantageously, using refresh time duration can enable data to be refreshed in advance of a user needing or accessing the information.

As previously described, refresh optimization preferences may also be used to identify an appropriate refresh schedule. In this regard, for example, based on a user selection to optimize cost (reduce costs), the refresh schedule can take into account a desire to minimize data refreshes when not needed or not generally needed by a group of users. As another example, based on a user selection to optimize data freshness, the refresh schedule can take into account a desire for a user or group of users to have updated data. Other preferences (e.g., specified by a user, administrator, developer, etc.) may include a maximum limit to a refresh frequency (e.g., no more than 1 refresh per day, etc.), a minimum limit to a refresh frequency (e.g., no less than 1 refresh per day, etc.), threshold value of cost for refreshes, predicted influence of refresh on final result of interest, or the like.

The refresh time identifier 234 may assess and utilize various data to identify a refresh schedule in any number of ways. In some cases, a refresh schedule may be determined based on statistical models. In other cases, a refresh schedule may be determined using any machine learning method or predictive modeling, which may be specified according to refresh logic 216.

As can be appreciated, the refresh schedule can be adaptable to the various types of data collected and analyzed. For instance, as a user or group of users begin requesting to view data more frequently, the refresh schedule can be updated to more frequently refresh data. As such, the data refresh manager 230 may operate continually, periodically, or otherwise as needed to provide an adaptable refresh schedule. By way of example only, assume user access to data reports/dashboards is being monitored and used to set a data refresh schedule. Further assume it is determined that users of a system typically review such information between 8 to 10 am Monday through Friday. Based on these patterns, data refreshes may be scheduled for 8 am Mondays through Fridays.

The refresh time provider 236 is generally configured to provide a time(s) at which to refresh data. In some cases, the refresh time provider 236 may provide a refresh schedule to a user device for presentation to a user. In such cases, the user may select to modify or approve the determined refresh schedule. Additionally or alternatively, the refresh time provider 236 may provide a refresh schedule, for example, to the data refresher 240 for use in scheduling data refreshes. Instead of providing a refresh schedule to a data refresher 240 for use in scheduling data refreshes, in some cases, the refresh time provider 236 may itself trigger initiation of data refreshes based on the determined refresh schedule. In this regard, at a time when a data refresh is scheduled, the refresh time provider 236 can provide a refresh notification to the data refresher 240 to initiate a data refresh.

The data refresher 240 is generally configured to refresh data. Generally, the data refresher 240 can refresh data 250 in accordance with a refresh time(s) or refresh schedule identified by the refresh time identifier 234. In some implementations, the data refresher 240 may obtain or access a refresh schedule to determine times at which to initiate a data refresh. In other implementations, the data refresh manager 230 (e.g., the refresh time provider 236) may provide an indication to the data refresher 240 to trigger or initiate a data refresh.

Data can be refreshed in any number of ways, and embodiments herein are not intended to be limited to any such data refresh flow. A data refresh flow or process refers to a method or procedures used to refresh data. One example of a refresh flow, or portion thereof, is ETL. ETL includes extracting data (e.g., from an operational system), transforming the data (e.g., clean it up, remove duplicates, etc.), and loading the data into a consumable database, such as a dataset within data store 214. CDS-A (common data set for analytics) is another example of a refresh flow, or portion thereof, that can be implemented to refresh data. In embodiments, a refresh flow may also include a data analysis service, or other server or service, utilizing the refreshed data to provide updated information to a user. By way of example, and with brief reference to FIG. 1, a first portion of a refresh flow may include a refreshing a dataset within the data store 114, and a second portion of a refresh flow may include the data analysis service 118 accessing the refreshed dataset and utilizing such data to provide updated information to a user device 110. For example, the data analysis service 118 may analyze the refreshed data and provide updated information to a user device such that the user device can provide a dashboard of various data visualizations. The refreshed data 250 can be output, for example, and stored in data store 214, or other data repository.

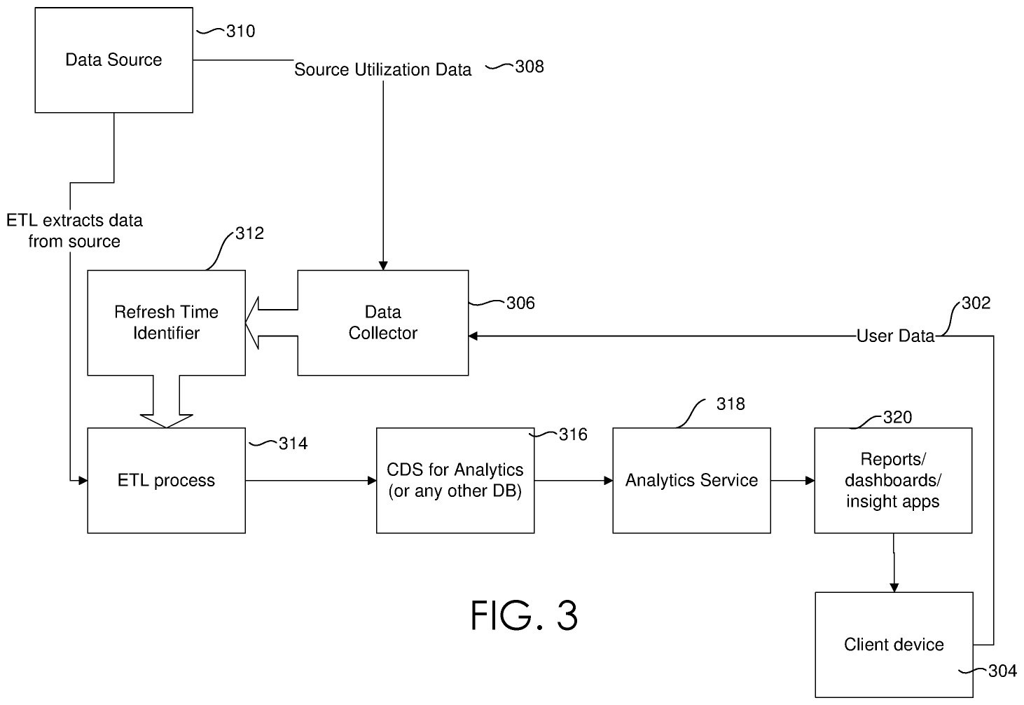

Turning now to FIG. 3, FIG. 3 provides one exemplary flow in accordance with embodiments described herein. The flow 300 illustrated in FIG. 3 can be performed by any number of computing devices. This process flow is only one example implementation. In process flow 300, user data 302 is provided from a client device 304 to the data collector 306. In embodiments, as user data 302 is detected at the client device 304, or on a periodic basis, the data can be provided to the data collector 306. Additionally, source utilization data 308 is provided from the data source 310 to the data collector 306. In embodiments, source utilization data 308 can be provided to the data collector 306 as the data is detected or determined, or on a periodic basis. The data collected at the data collector 306 can be accessed by the refresh time identifier 312 to identify an appropriate or optimal time for performing data refreshment. As described, in some cases, a next time may be identified. In other cases, a sequence or set of times may be identified for performing data refreshing. Artificial intelligence, such as machine learning methods, can be employed to utilize the data to determine an appropriate refresh schedule.

In accordance with an identified refresh time, the refresh time identifier 312 can initiate or trigger a refresh flow. As shown in FIG. 3, the refresh time identifier 312 can initiate an ETL process 314 in which data is extracted from the data source 310, transformed, and loaded to generate a refreshed data set. Thereafter, a CDS-A process 316 (common data set for analytics process) can be performed. At block 318, an analytics service can access the refreshed data and use the refreshed data to provide information for reports, dashboards, and applications 320, which can be provided to the client device. As such, the client device can present up-to-date information in accordance with the identified optimal refresh schedule.

### Exemplary Implementations for Facilitating Enhancement of Data Refresh Timing

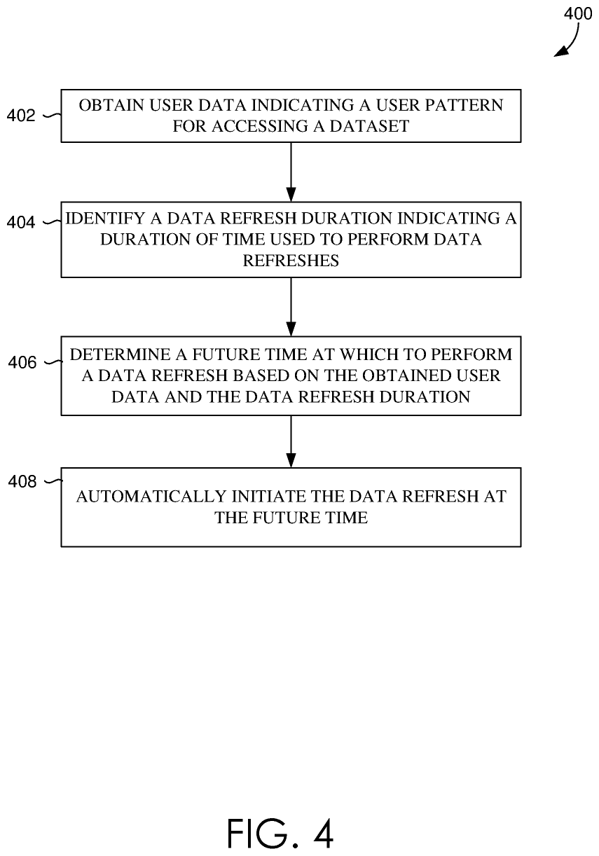

As described, various implementations can be used in accordance with embodiments of the present invention. FIGS. 4-6 provide methods of facilitating enhancement of data refresh timing or scheduling, in accordance with embodiments described herein. The methods 400, 500, and 600 can be performed by a computer device, such as device 700 described below. The flow diagrams represented in FIGS. 4-6 are intended to be exemplary in nature and not limiting.

Turning initially to method 400 of FIG. 4, method 400 is directed to facilitating enhancement of data refresh timing such that data is refreshed in advance of a user needing the data refresh, in accordance with embodiments of the present invention. Initially, at block 402, user data indicating a user pattern for accessing a dataset is obtained. Such user data can be initially collected at a user device, or a server associated therewith. In this regard, a user device, or portion associated therewith, may track what data a user accesses and when. This user data may be obtained in an ongoing manner or on a periodic basis. At block 404, a data refresh duration is identified. A data refresh duration can indicate a duration of time used to perform data refreshes. In embodiments, a data refresh duration may be represented by an average and standard deviation. Further, a data refresh duration may be specific to a user, the dataset being accessed, an application, a system, or the like. At block 406, a future time at which to perform a data refresh is determined based on the obtained user data and the data refresh duration. In embodiments, the future time is predicted to enable the data refresh to occur prior to a user accessing the dataset. For example, assume a user is expected to access a dataset at 8:00 am each morning and the data refresh typically takes one hour to perform. In such a case, the future time at which to perform a data refresh may be 7:00 am each morning. At the determined future time, a data refresh can be automatically initiated or triggered, as indicated at block 408. In this way, updated information can be provided to a user as the user, or just before, is ready to view information. Advantageously, the updated information is provided to the user without the user needing to wait the one hour refresh time to view up-to-date information. As can be appreciated, this process can be an iterative process such that a refresh time or schedule can adapt as data (e.g., user activity) changes.

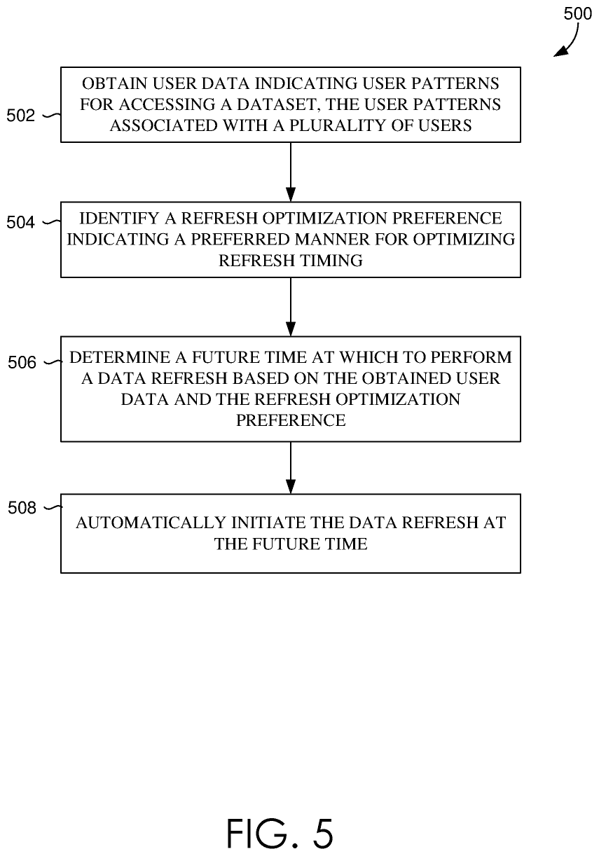

Turning now to FIG. 5, method 500 is directed to facilitating enhancement of data refresh timing such that data is refreshed in accordance with a user optimization preference, according to embodiments of the present invention. Initially, at block 502 user data indicating user patterns for accessing a dataset is obtained. In embodiments, the user patterns correspond with a plurality of users, for example, of a particular system, enterprise, or application. At block 504, a refresh optimization preference is identified. The refresh optimization preference can indicate a preferred manner for optimizing refresh timing. For example, a refresh optimization preference may indicate a preference for refresh timing optimization based on data freshness or cost reduction. As can be appreciated, in embodiments, a refresh optimization preference is provided via an administrator or other representative of the system, enterprise, or application associated with the data refreshes. At block 506, a future time at which to perform a data refresh is determined based on the obtained user data and the refresh optimization preference. In embodiments, the future time can be predicted to optimize refresh timing in accordance with the refresh optimization preference and the user patterns, for example, to reduce costs or increase data freshness, while taking into account user access patterns. At block 508, a data refresh can be automatically initiated at the future time. In this way, updated information can be provided to a user, while attempting to reduce execution costs or increase data freshness. As can be appreciated, this process can be an iterative process such that a refresh time or schedule can adapt as data (e.g., user activity) changes.

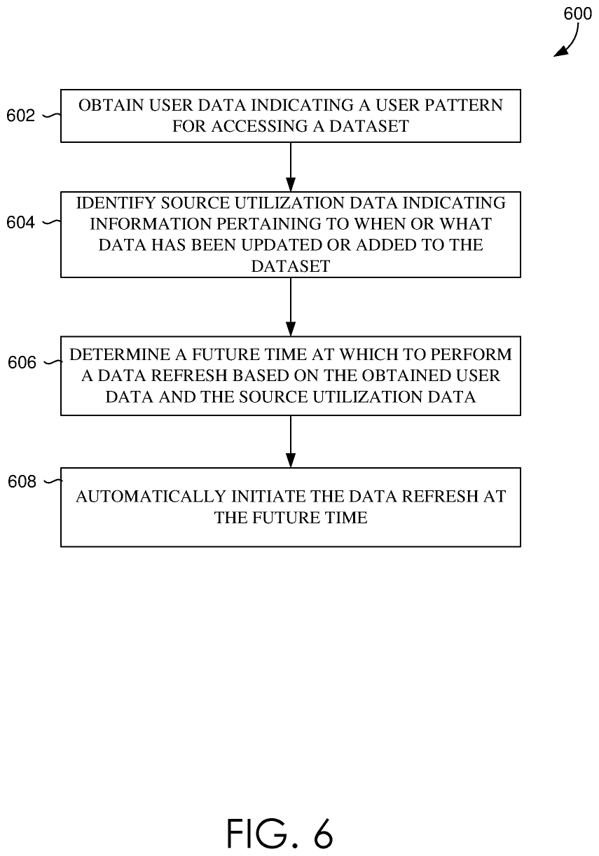

With reference now to FIG. 6, method 600 is directed to facilitating enhancement of data refresh timing such that data is refreshed in accordance with source data utilization, according to embodiments of the present invention. Initially, at block 602 user data indicating a user pattern for accessing a dataset is obtained. Such user data can be initially collected at a user device, or a server associated therewith. In this regard, a user device, or portion associated therewith, may track what data a user accesses and when. This user data may be obtained in an ongoing manner or on a periodic basis. At block 604, source utilization data indicating information pertaining to when or what data has been updated or added to the dataset is identified. At block 606, a future time at which to perform a data refresh is determined based on the obtained user data and the source utilization data. In embodiments, the future time is predicted to optimize refresh timing in accordance with the user data and the source utilization data. By way of example only, assume based on a user pattern, a refresh would be beneficial to the user. However, because no data in a dataset has been modified or added recently, a data refresh can be avoided to reduce resource utilization. As another example, assume that a large amount of data has been added to a dataset. In such a case, a data refresh schedule can be identified to refresh data in the near future such that a subsequent data refresh is not as time consuming. At block 608, a data refresh is automatically triggered or initiated in accordance with the future time. As a result, up-to-date information can be provided to a user(s), while reducing resource utilization. As can be appreciated, this process can be an iterative process such that a refresh time or schedule can adapt as data (e.g., user activity, source utilization data) changes.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein. Neither should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 7 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, vibrating component, etc. I/O port(s) 718 allow computing device 700 to be logically coupled to other devices including I/O components 720, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 700. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to:
obtain user data indicating a user pattern for accessing a dataset;
identify a data refresh duration indicating a duration of time used to perform a prior data refresh;
determine a future time at which to perform a data refresh based on the obtained user data and the data refresh duration, the future time predicted to enable the data refresh to occur prior to a user accessing the dataset; and
automatically initiate the data refresh at the future time.

2. The computing system of claim 1, wherein the user data is obtained from a user device collecting the user data.

3. The computing system of claim 1, wherein the data refresh duration indicates an average amount of time to perform a plurality of prior data refreshes.

4. The computing system of claim 1, wherein the data refresh duration indicates an average amount of time to perform a plurality of prior data refreshes in association with the user or the dataset.

5. The computing system of claim 1, wherein the future time is determined using a machine learning model.

6. The computing system of claim 1, wherein the future time is determined using a statistical model.

7. The computing system of claim 1 further comprising:
receiving, via a graphical user interface, a refresh optimization preference from the user; and
utilizing the refresh optimization preference to determine the future time at which to perform the data refresh.

8. The computing system of claim 7, wherein the refresh optimization preference comprises a preference to optimize data refreshes based on cost reduction, resource reduction, or data freshness.

9. A computer-implemented method comprising:
obtaining user data indicating user patterns for accessing a dataset, the user patterns associated with a plurality of users;
identifying a refresh optimization preference indicating a preferred manner for optimizing refresh timing;
determining a future time at which to perform a data refresh based on the obtained user data and the refresh optimization preference, the future time predicted to optimize refresh timing in accordance with the refresh optimization preference and the user patterns; and
automatically initiating the data refresh at the future time.

10. The method of claim 9, wherein the plurality of users are users of a particular system.

11. The method of claim 9 further comprising:
receiving, via a graphical user interface, a refresh optimization preference from an administrator of a particular system utilized by the plurality of users; and
utilizing the refresh optimization preference to determine the future time at which to perform the data refresh.

12. The method of claim 11, wherein the refresh optimization preference comprises a preference to optimize data refreshes based on cost reduction, resource reduction, or data freshness.

13. The method of claim 9 further comprising:
receiving source utilization data indicating information pertaining to when or what data has been updated or added to the dataset; and
utilizing the source utilization data to determine the future time at which to perform the data refresh.

14. The method of claim 9 further comprising:
receiving a data refresh duration indicating a duration of time used to perform a prior data refresh; and
utilizing the data refresh duration to determine the future time at which to perform the data refresh.

15. The method of claim 14, wherein the data refresh duration comprises an average amount of time to perform a plurality of prior data refreshes in association with the plurality of users or the dataset.

16. One or more computer storage media having computer-executable instructions embodied thereon that, when executed by one or more processors, cause the one or more processors to perform a method, the method comprising:
obtaining user data indicating a user pattern for accessing a dataset;
identifying source utilization data indicating information pertaining to when or what data has been updated or added to the dataset;
determining a future time at which to perform a data refresh based on the obtained user data and the source utilization data, the future time predicted to optimize refresh timing in accordance with the user data and the source utilization data;
automatically initiating the data refresh at the future time.

17. The media of claim 16, wherein the future time predicted to optimize refresh timing is delayed when the source utilization data indicates data in the dataset has not been added or modified within a threshold amount of time.

18. The media of claim 16, wherein the future time predicted to optimize refresh timing is advanced when the source utilization data indicates a threshold amount of data has been added to the dataset or data has been added to the dataset within a threshold amount of time.

19. The media of claim 16 further comprising performing the data refresh at the future time by at least triggering an extract, transform, and load process.

20. The media of claim 16 further comprising: causing presentation of the determined future time at which to perform a data refresh, and receiving a confirmation or modification of the determined future time.
